(19) United States
(12) Patent Application Publication
(10) Pub. No.: US 2014/0241332 A1
(43) Pub. Date: Aug. 28, 2014

(54) System and Method for Indicating and Acquiring Information of an Access Point

(71) Applicant: FutureWei Technologies, Inc., Plano, TX (US)

(72) Inventors: Yunsong Yang, San Diego, CA (US); Zhigang Rong, San Diego, CA (US); Young Hoon Kwon, San Diego, CA (US)

(73) Assignee: FutureWei Technologies, Inc., Plano, TX (US)

(21) Appl. No.: 14/186,966

(22) Filed: Feb. 21, 2014

Related U.S. Application Data
(60) Provisional application No. 61/770,205, filed on Feb. 27, 2013.

(51) Int. Cl. H04W 24/08

(52) U.S. Cl. CPC H04W 24/08
USPC 370/338

(57) ABSTRACT

A method for operating a transmitting device includes generating a configuration index (CI) information element (IE), the CI IE including a CI value and an indicator of a completeness of a configuration information included with the CI IE, wherein the completeness of the configuration information included with the CI IE is one of complete information and simplified information, and placing the CI IE in a frame. The method also includes transmitting the frame.

This application claims the benefit of U.S. Provisional Application No. 61/770,205, filed on Feb. 27, 2013, entitled “Systems and Methods for Indicating and Acquiring Information of an Access Point,” which application is hereby incorporated herein by reference.

### TECHNICAL FIELD

The present disclosure relates generally to digital communications, and more particularly to a system and method for indicating and acquiring information of an access point.

### BACKGROUND

The number of devices using Wireless Local Area Networks (WLAN) continues to show dramatic growth. WLANs allow users the ability to connect to high-speed services without being tethered to wireline connections. WLANs are wireless communications systems that are based on the IEEE 802.11 series of technical standards. Typically, as the number of devices using WLANs increases, the density of devices in the WLANs (e.g., access points (APs) and stations (STA)) will also increase. High densities of APs (also commonly referred to as communications controller, controller, and the like) and stations (also commonly referred to as user, subscriber, terminal, and the like) tend to make WLANs less efficient, especially since the original WLANs were designed assuming a low density of APs and stations.

### SUMMARY OF THE DISCLOSURE

Example embodiments of the present disclosure which provide a system and method for indicating and acquiring information of an access point.

In accordance with an example embodiment of the present disclosure, a method for operating a transmitting device is provided. The method includes generating, by the transmitting device, a configuration index (CI) information element (IE), the CI IE including a CI value and an indicator of a completeness of a configuration information included with the CI IE, wherein the completeness of the configuration information included with the CI IE is one of complete information and simplified information. The method also includes placing, by the transmitting device, the CI IE in a frame, and transmitting, by the transmitting device, the frame.

In accordance with another example embodiment of the present disclosure, a method for operating a transmitting device in an IEEE 802.11ai compliant communications system is provided. The method includes generating, by the transmitting device, a configuration change count (CCC) information element (IE), the CCC IE including a CCC value and an indicator of a completeness of a configuration information included with the CCC IE, wherein the completeness of the configuration information included with the CCC IE is one of a full set of a Configuration Information Set and a reduced set of the Configuration Information Set. The method also includes placing, by the transmitting device, the CCC IE in a frame, and transmitting, by the transmitting device, the frame.

In accordance with another example embodiment of the present disclosure, a transmitting device is provided. The transmitting device includes a processor, and a transmitter operatively coupled to the processor. The processor generates a configuration index (CI) information element (IE), the CI IE including a CI value and an indicator of a completeness of a configuration information included with the CI IE, wherein the completeness of the configuration information included with the CI IE is one of complete information and simplified information, and places the CI IE in a frame. The transmitter transmits the frame.

In accordance with another example embodiment of the present disclosure, an IEEE 802.11ai compliant transmitting device is provided. The IEEE 802.11ai compliant transmitting device includes a processor, and a transmitter operatively coupled to the processor. The processor generates a configuration change count (CCC) information element (IE), the CCC IE including a CCC value and an indicator of a completeness of a configuration information included with the CCC IE, wherein the completeness of the configuration information included with the CCC IE is one of a full set of a Configuration Information Set and a reduced set of the Configuration Information Set, and places the CCC IE in a frame. The transmitter transmits the frame.

One advantage of an embodiment is that stations not issuing a request resulting in a received response may be able to readily determine if a received response contained simplified information or complete information about an access point.

A further advantage of an embodiment is that stations, even those that is not the station making the request resulting in the received response, may take advantage of simplified information contained in the received response, thereby reducing communications overhead.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates a first example communications system according to example embodiments described herein;

FIG. 2 illustrates a second example communications system according to example embodiments described herein;

FIG. 3 illustrates an example record of stored information regarding APs according to example embodiments described herein;

FIG. 4 illustrates an example record of current Configuration Information Set according to example embodiments described herein;

FIG. 5 illustrates an example simplified record of past Configuration Information Sets according to example embodiments described herein;

FIG. 6 illustrates an example update of records of current and past Configuration Information Sets by an AP according to example embodiments described herein;

FIG. 7 illustrates an example of IE selection for a simplified Probe Response according to example embodiments described herein;

FIG. 8 illustrates a flow diagram of example operations occurring in a transmitting device as the transmitting device transmits frame comprising a CCC IE according to example embodiments described herein;

FIG. 9a illustrates a portion of a first example CCC IE according to example embodiments described herein;

FIG. 9b illustrates a portion of a second example CCC IE according to example embodiments described herein;

FIG. 10 illustrates a flow diagram of example operations occurring in a receiving station as the receiving station receives a frame comprising a CCC IE according to example embodiments described herein; and

FIG. 11 illustrates an example communications device according to example embodiments described herein.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the disclosure and ways to operate the disclosure, and do not limit the scope of the disclosure.

One embodiment of the disclosure relates to indicating and acquiring information of an access point. For example, a transmitting device generates a configuration index (CI) information element (IE), the CI IE including a CI value and an indicator of a completeness of a configuration information included with the CI IE, wherein the completeness of the configuration information included with the CI IE is one of complete information and simplified information. The transmitting device also places the CI IE in a frame, and transmits the frame.

The present disclosure will be described with respect to example embodiments in a specific context, namely an IEEE 802.11ai compliant communications system that uses active scanning and passive scanning for access point/network discovery. The disclosure may also be applied, however, to other standards compliant, such as IEEE 802.11aq, The Third Generation Partnership Project (3GPP) or Machine to Machine (e.g. oneM2M) technical standards, and non-standards communications systems that use scanning for access point/network discovery.

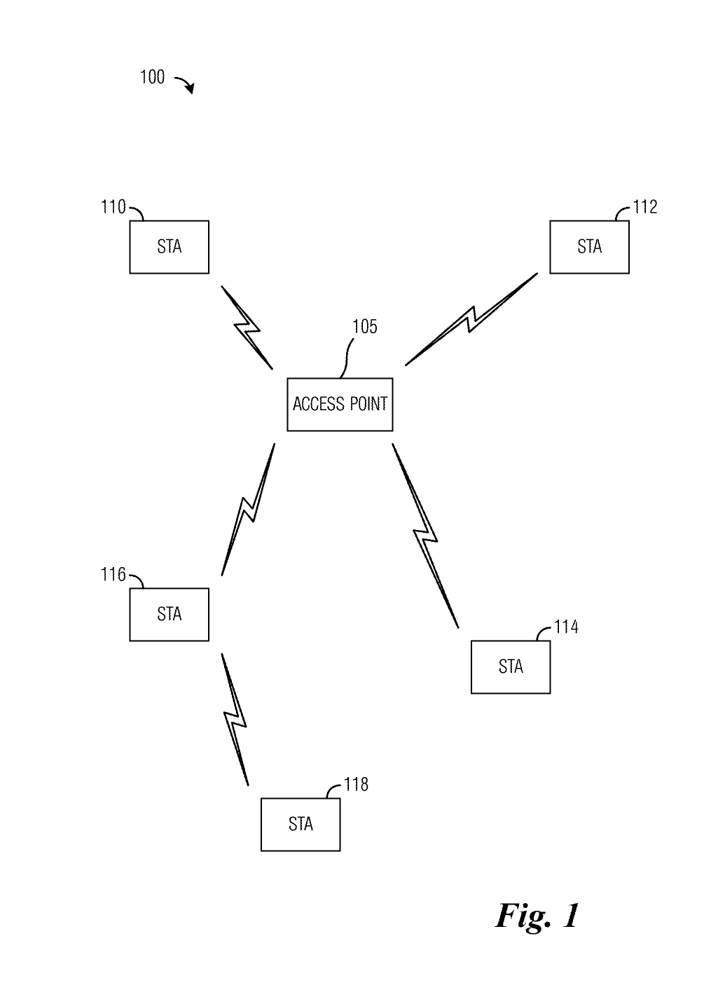

FIG. 1 illustrates a first example communications system 100. Communications system 100 includes an access point (AP) 105 that is serving a plurality of devices, such as device 110, device 112, device 114, device 116, and device 118. An AP may also be commonly referred to as a base station, a communications controller, a controller, a NodeB, an evolved NodeB (eNB), and the like. A device may also be commonly referred to as a station, a user equipment (UE), a mobile station, a mobile, a user, a subscriber, a terminal, and the like. In a first communications mode, the devices may communicate through AP 105 by transmitting a frame to AP 105, which forwards the frame to its intended recipient. In a second communications mode, a first device may transmit a frame directly to a second device without having to go through AP 105.

While it is understood that communications systems may employ multiple APs capable of communicating with a number of stations, only a single AP, and a number of devices are illustrated in FIG. 1 for simplicity.

Conventionally, a connection between devices, such as Wi-Fi devices, needs to be established, which is accomplished by a successful completion of authentication, association, and in some cases, the IP address assignment, before service data may be exchanged between the devices. However, the amount of signaling overhead and delay incurred by the authentication, association, and IP address assignment procedures may become undesirable if the requested services can't be met by the connected device, since the signaling overhead and delay are wasted and other service providers are sought out. Thus, the notion of pre-association discovery has been introduced, wherein the procedure for discovering devices and the services that the devices provide, or at least a part of this procedure, is conducted before a connection is made, i.e., before the authentication and association procedure. In this way, the connection is established between the devices only when the requested services can be met.

Primary mechanisms for device discovery in Wi-Fi are passive scanning and active scanning. In passive scanning, a first Wi-Fi device listens to a Beacon frame that is transmitted by a second Wi-Fi device. Based on the received Beacon frame, the first Wi-Fi device discovers the second Wi-Fi device. Since a Beacon frame is usually broadcasted once a while (normally on the order of 100 milliseconds), the first Wi-Fi device suffers long delay and high power consumption in discovering the second Wi-Fi device using the passive scanning. In active scanning, a requesting Wi-Fi device (or a seeker Wi-Fi device) transmits a request frame, such as a Probe Request frame, which may include the information of a requested Wi-Fi device or a requested service. A Wi-Fi device that matches with the information of the requested Wi-Fi device or the requested service (also commonly referred to as a responding Wi-Fi device) responds back by sending a response frame, such as a Probe Response frame, which may include more information of the responding Wi-Fi device or the requested service such that the requesting (or seeker) Wi-Fi device may decide to make a connection with the responding Wi-Fi device or not. Hence, active scanning allows faster discovery, comparing to passive scanning, but uses additional air time for signaling overhead. Active scanning may not scale well in crowded environments. As an example, if Wi-Fi applications on devices were all using active scanning in a crowded venue to continuously discover peers, there would be an excessive amount of traffic just carrying the Probe Request and Probe Response frames alone.

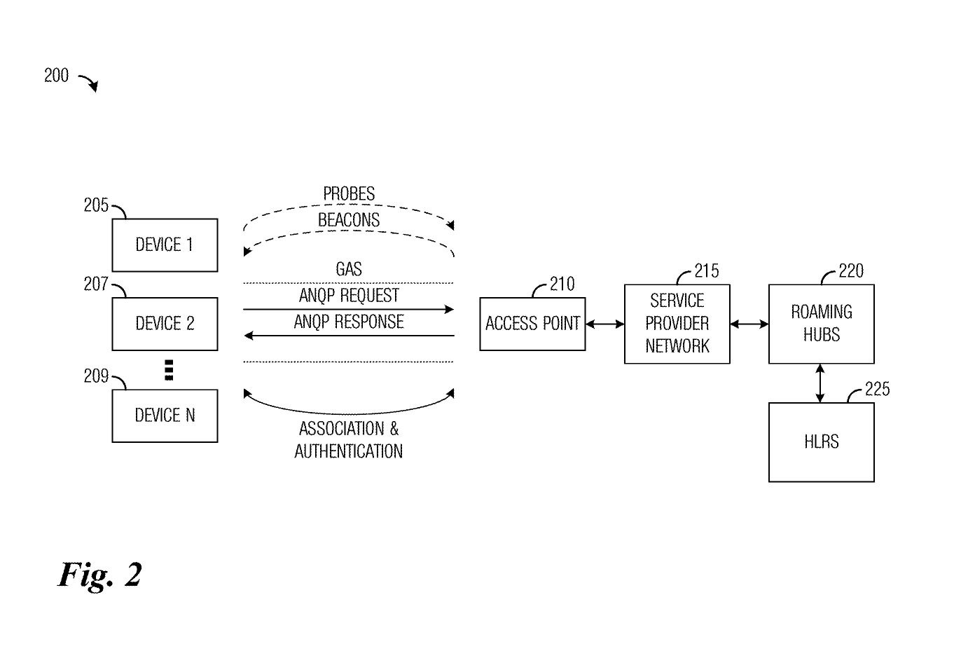

In addition to device discovery, IEEE 802.11u provides network discovery mechanisms based on the transmission of a group of Public Action frames, which are known as the Generic Advertisement Service (GAS) Request and GAS Response frames and are used to carry the query data and response data for advertisement protocols such as Access Network Query Protocol (ANQP). FIG. 2 illustrates the GAS and ANQP operation. First, a user of a device initiates the intention to connect to Wi-Fi, and the user's device scans for available access points, which are also referred to as the Wi-Fi hotspots. In IEEE 802.11u, GAS frames are used to provide for Layer 2 transport of query data and response data of an advertisement protocol between the client on the user's device and a server in the network prior to authentication and association. In IEEE 802.11u, ANQP is a particular advertisement protocol used to discover different features and available services of the access network. After receiving the ANQP response data, the user's device selects a particular AP, and then proceeds with the authentication and association procedures which results in the establishment of a connection with the AP.

FIG. 2 illustrates a second example communications system 200. Communications system 200 may be an example of a Wi-Fi compliant communications system. Communications system 200 may utilize communications services and protocols, such as GAS and ANQP, to support operations including scanning and network selection. In general, GAS frames may be used to provide Layer 2 transport of query data and response data of an advertisement protocol, such as ANQP, between a terminal and a server in a communications system, such as communications system 200, prior to or post authentication (of the terminal, for example). Typically, ANQP may be used to discover different features and/or services of the communications system. A device compares the information regarding different networks or access points to select the best suitable to associate with. The device may proceed with an authentication process.

Usually, a station may be used to refer to any of the devices (such as devices 205, 207, and 209) shown in FIG. 2, which may include a cell phone, a laptop computer, a tablet, a smart sensor, a handheld or consumer electronic device, as well as other devices that have an interface (such as a Wi-Fi interface) that can interact with communications system 200. Some or all of the stations may also be able to interact with other types of communications systems, such as cellular networks, Bluetooth, proprietary networks, and the like.

An AP 210 and one or more stations may form a basic service set (BSS), which is the basic building block of a Wi-Fi communications system. A BSS may be identified by a service set identifier (SSID), which is a configured identifier and may be broadcasted by an AP of the BSS, such as AP 210. AP 210 may communicate with an AP controller or/and an ANQP server, which can be co-located or not with AP 210. AP 210 may be connected to a service provider network 215, which is connected to one or more roaming hubs 220. Roaming hubs 220 may be connected to home location register (HLRs) 225. Roaming hubs 220 and HLRs 225 provide support for device mobility, i.e., roaming.

An AP Configuration Information Set is a set of information fields and elements in the Beacon or Probe Response frame, excluding the following dynamic information field and elements: TimeStamp field, Time Advertisement element, BSS AC access delay element, BSS average access delay element, BSS available admission capacity element, TPC report element, Beacon timing element, and BSS load element. The AP Configuration Information Set provides the static or semi-static part of an AP's configuration information.

Active scanning, which is used by stations to discover an AP to access, involves a first step where a station sends a Probe Request with the service set identifier (SSID) of the AP that it is searching for, and a second step where the AP being searched for, in response to the Probe Request, sends a Probe Response with its configuration information such that the station may determine if it will proceed with the association with the AP.

In crowded environments, such as train stations, many stations may scan an AP simultaneously, causing a signaling jam and delay in getting responses. To overcome this, IEEE 802.11ai proposes that an AP broadcast a configuration change count (CCC) value. A CCC value may be an index associated with a particular set of contents of a set of configuration information, which are expressed in the form of information elements (IEs) and are collectively referred as the Configuration Information Set. A device, such as an AP and/or a station, uses the contents of the Configuration Information Set for configuration purposes. A more generic term for a CCC may be a configuration index (CI) or configuration sequence number (CSN). Without loss of generality, the discussion presented below utilizes CCC to discuss example embodiments presented herein, however, the example embodiments also apply to CI or CSN.

The CCC value is incremented by the AP when the content of any information field or element among the AP's Configuration Information Set is changed. The AP may memorize the CCC values and corresponding contents of its Configuration Information Set that it may have broadcasted before. A station may memorize the CCC value and corresponding contents of the Configuration Information Set of the AP that it may have associated or encountered before. When searching for the same AP again, the STA indicates, in a Probe Request, the CCC value that it memorized for the AP. The AP then may respond with a simplified Probe Response, knowing what information element, if any, among the AP's Configuration Information Set has been changed since the CCC value, which is memorized by the station before and indicated by the station in the corresponding Probe Request. Comparing to a normal Probe Response that includes all the information elements among the Configuration Information Set, a simplified Probe Response is simplified in a sense that it includes a reduced or partial set of the information elements among the Configuration Information Set.

However, in a situation when a station does not transmit a Probe Request with a CCC value, the station may still need to be able to determine whether a Probe Response with a CCC information element (IE) is a normal (or complete or regular or full) Probe Response which contains a complete set of information elements among the Configuration Information Set or a simplified Probe Response which includes a partial set of the information elements among the Configuration Information Set. If the Probe Response is a normal Probe Response, the station may establish or update its record of stored configuration information regarding the AP. Additionally, if the simplified Probe Responses are not broadcasted, other stations will not be able to make use of the information in the simplified Probe Response to update their record of stored configuration information regarding the AP.

According to an example embodiment, the configuration of a Probe Response, as well as when and/or how it is transmitted, may be altered to address the above discussed situations. As an example, rather than transmitting only the CCC value, an indicator of a completeness, e.g., normal or simplified, of the configuration information included in the same frame, may be transmitted with the CCC value. As another example, instead of broadcasting normal Probe Responses and unicasting simplified Probe Responses, both types of Probe Responses may be broadcasted.

According to an example embodiment, a station may need to have complete and up-to-date information regarding the configuration of an AP in order to proceed with an association procedure with the AP successfully. Therefore, the station may need to know a complete set of the current contents of the Configuration Information Set for the AP that it has associated with previously. The Configuration Information Set may include IE identifiers (IE IDs) and contents of all IEs within the Configuration Information Set. The station may also need to know a CCC value that corresponds to a particular set of contents of the Configuration Information Set.

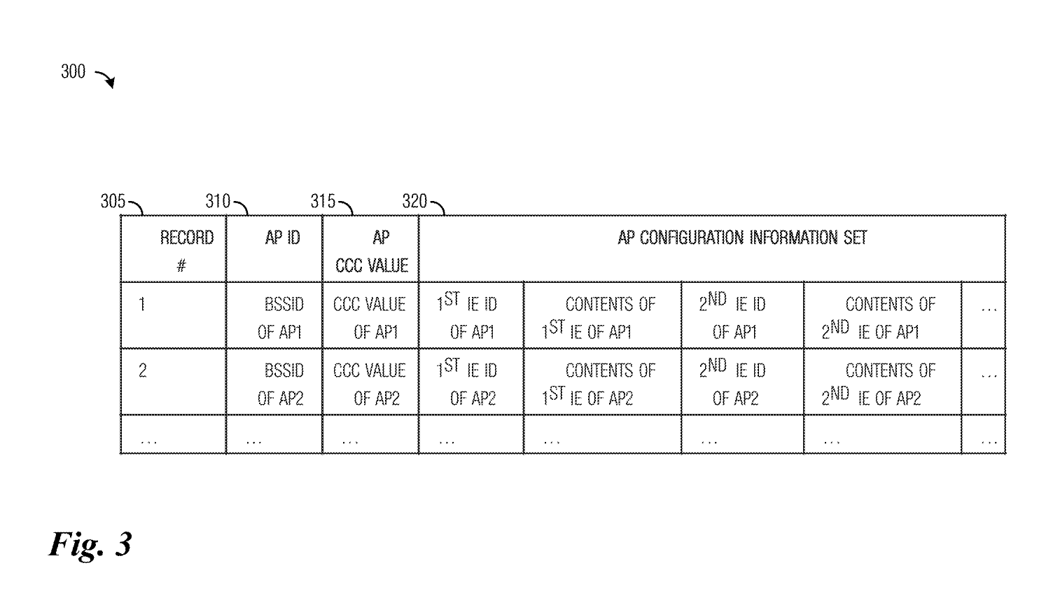

FIG. 3 illustrates an example record of stored information 300 regarding APs. Record 300 of stored information may include information arranged into a record number (RECORD #) field 305, an AP identifier (AP ID) field 310, an AP CCC Value field 315, and an AP Configuration Information Set field 320. As shown in FIG. 3, AP Configuration Information Set field 320 may include a plurality of IE IDs and the content of each corresponding IE ID. The station may maintain a record for one or more APs. As an example, consider a user with a cellular telephone who travels between home and work via light rail. The cellular telephone may maintain a record for APs that it encounters at the various stations of the light rail, at work, at home, and the like.

According to an example embodiment, an AP may maintain a complete record of its current Configuration Information Set and current CCC value. The current Configuration Information Set may include IE IDs and the current contents of all IEs within the Configuration Information Set.

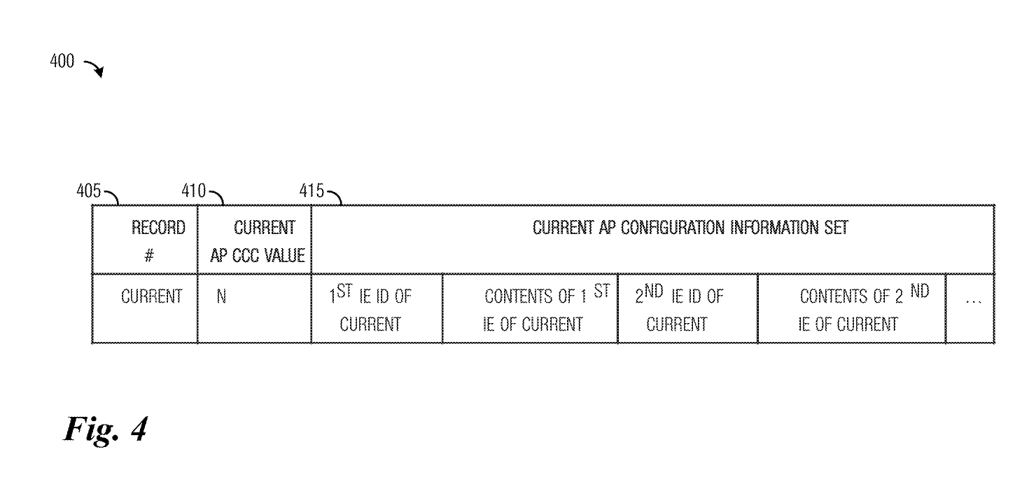

FIG. 4 illustrates an example record 400 of current Configuration Information Set. Record 400 of current Configuration Information Set may include information arranged into a record number (RECORD #) field 405, a current AP CCC Value field 410, and a current AP Configuration Information Set field 415. As shown in FIG. 4, current AP Configuration Information Set field 415 may include a plurality of IE IDs and the content of each corresponding IE ID. Additionally, the AP may maintain similar records of Configuration Information Sets and associated CCCs for previous AP configurations at the expense of storage space.

According to an example embodiment, the AP may maintain a simplified record of past Configuration Information Sets and associated CCC values. The AP may record a list of CCC values of its past Configuration Information Sets and the changes (i.e., differences) made in intermediate configurations over each earlier configuration.

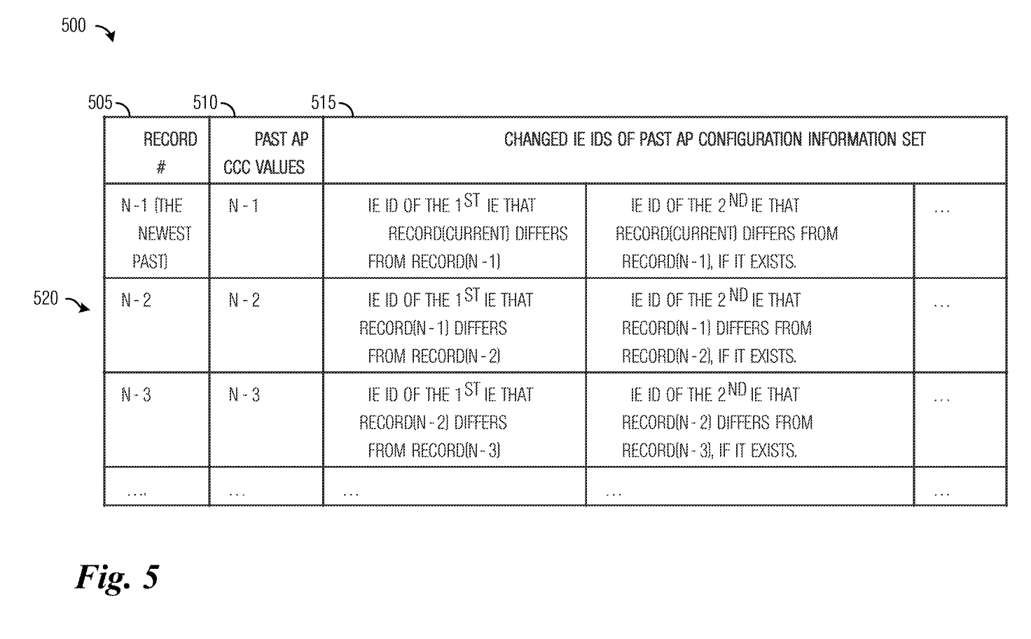

FIG. 5 illustrates an example simplified record 500 of past Configuration Information Sets. Simplified record 500 of past Configuration Information Sets may include information arranged into a record number (RECORD #) field 505, a past AP CCC Value field 510, and changed IE IDs of past Configuration Information Sets field 515. Changed IE IDs of past Configuration Information Sets field 515 may include IE IDs of IEs of a Configuration Information Set with an associated CCC value, the contents of which IEs have changed from those of an earlier Configuration Information Set. As an illustrative example, consider row 520 of simplified record 500. Row 520 includes a simplified record of past Configuration Information Set associated with CCC value N−2, where N is an integer value corresponding to a current Configuration Information Set. In changed IE IDs of past Configuration Information Sets field 515 for row 520, the AP may store IE ID(s) of IEs that differ from IEs with the same IE ID(s) in past Configuration Information Set associated with CCC value N−1. In general, changed IE IDs of past Configuration Information Sets field 515 associated with CCC value N−m may be used to store IE IDs of IEs that differ from IEs with the same IE IDs in a past Configuration Information Set associated with CCC value N−m+1, where m is an integer value.

When a change occurs to any IE in the Configuration Information Set of an AP, the AP may need to update its records of current and past Configuration Information Sets. According to an example embodiment, the AP may utilize the following technique to update its record of current and past Configuration Information Sets:

a. Add a new current incident, which corresponds to a row in the record of current Configuration Information Sets (such as shown in FIG. 4) with the CCC value being set to the CCC value of the previous current incident plus 1;

b. Add a new past incident, which corresponds to a row in the simplified record of past Configuration Information Sets (such as shown in FIG. 5) with the CCC value being set to the CCC value of the previous current incident, and

i. compare the content of each IE within the Configuration Information Set between the new current incident and the previous current incident to identify any changed IEs, and

ii. add the IDs of changed IEs identified in step i to the new past incident in the simplified record of past Configuration Information sets; and

c. Remove the previous current incident from the record of current Configuration Information Sets.

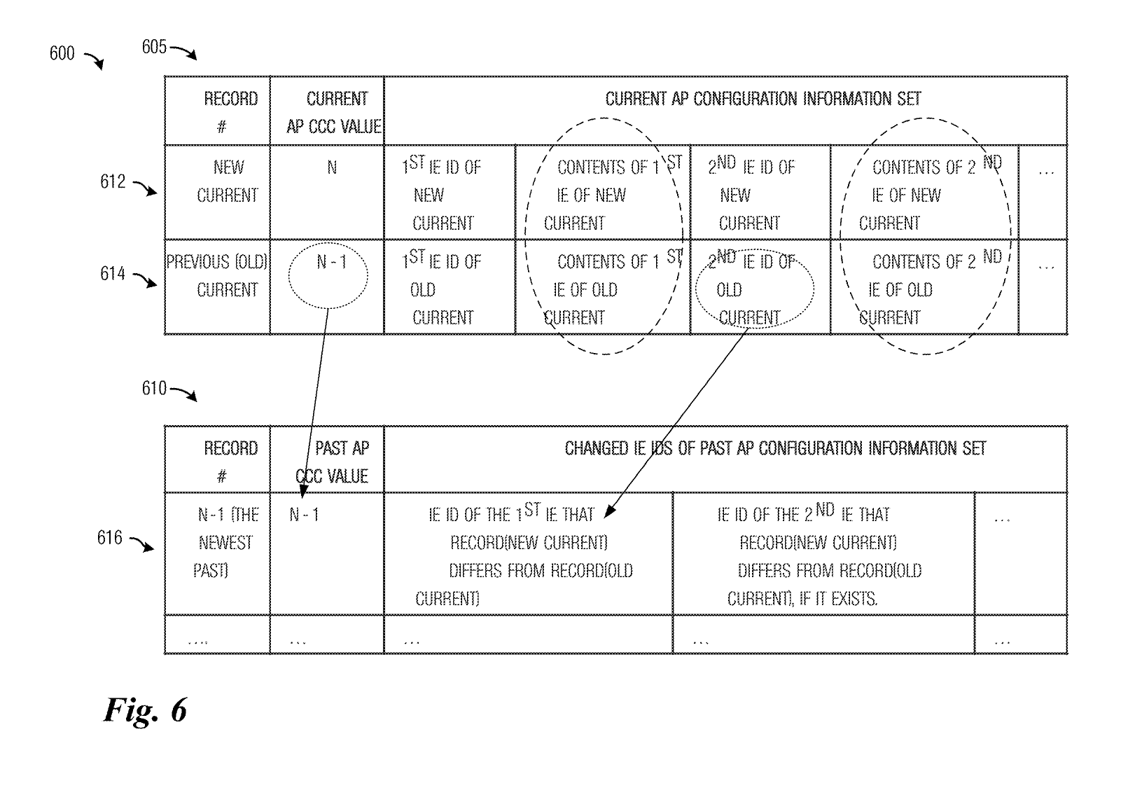

FIG. 6 illustrates an example update 600 of records of current and past Configuration Information Sets by an AP. Typically, an update resulting from a change in one or more IEs in the Configuration Information Set of an AP involves changes in both a record of current Configuration Information Set 605 and a simplified record of past Configuration Information Sets 610. As discussed earlier, the AP may add a new current incident (shown as row 612 in record of current Configuration Information Set 605) with the CCC value being set to the CCC value of the previous current incident (shown as row 614) plus 1. For illustrative purposes, the CCC value of the new current incident is set to N, an integer value, and the CCC value of the previous current incident is set to N−1. The AP may also add a new past incident (shown a row 616 of simplified record of past Configuration Information Sets 610) with the CCC value of the previous current incident.

The AP may compare the IEs of the new current incident and the previous current incident. For discussion purposes, consider a situation where the first IE of the new current incident and the previous current incident is unchanged and where the second IE of the new current incident and the previous current incident is changed. Therefore, the AP may store the IE ID of the second IE in a past Configuration Information Sets field in the new past incident (row 616).

According to an example embodiment, the AP maintains the IE IDs of the IEs that changed in the Configuration Information Sets and not the actual IE contents. This reduction of memory requirement may be possible since in a Probe Request, a station provides the CCC value of a configuration that it had associated for the AP before. Upon receipt of the Probe Request, the AP may determine if the CCC value provided by the station is its current CCC value or not. If the CCC value provided by the station is the current CCC value of the AP, then no IEs within the Configuration Information Set needs to be provided by the AP in a simplified Probe Response. If the CCC value provided by the station is not the current CCC value of the AP, then the AP may parse through its simplified records of past Configuration Information Sets, more specifically, from the record associated with the CCC value provided by the station up to the record associated with the CCC value associated with the current incident, and determine which IEs have been changed by sequentially going through the records of past Configuration Information Sets and reconstructing these IEs as if they are specifically requested by the station. Therefore, the AP may provide the changed IEs, which is a partial set of the IEs in the Configuration Information Set, including the IE IDs and the current contents associated with these IE IDs to the station, in a simplified Probe Response.

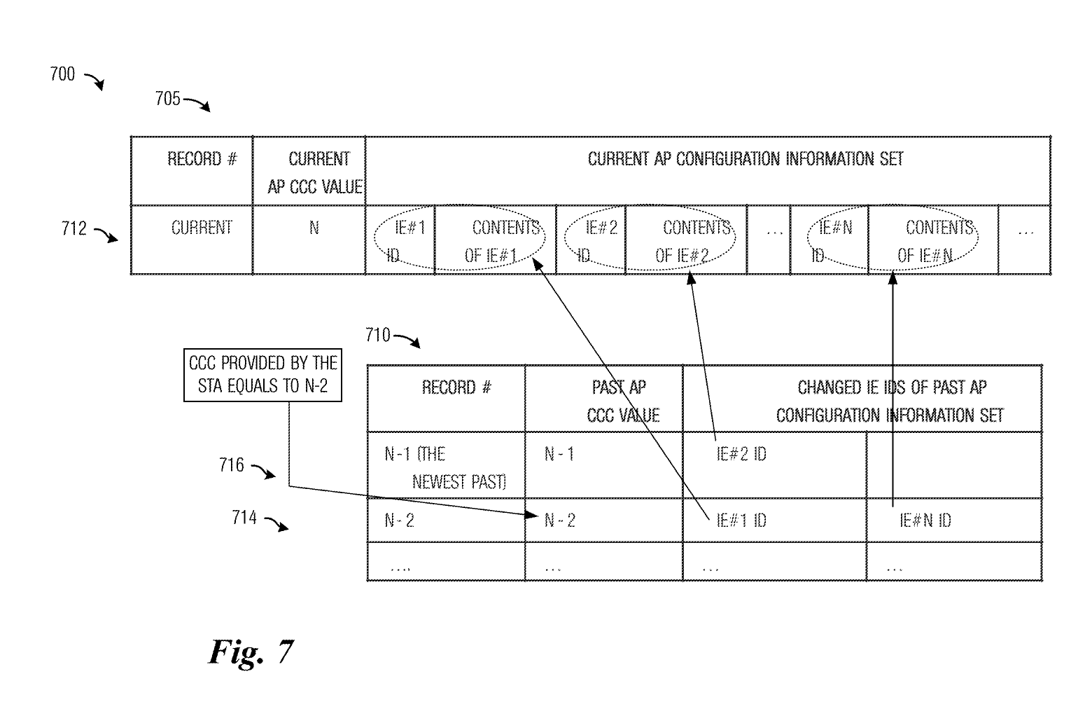

FIG. 7 illustrates an example of IE selection 700 for a simplified Probe Response. IE selection 700 may involve information from both a record of current Configuration Information Set 705 and a simplified record of past Configuration Information Sets 710. For illustrative purposes, consider a situation where the AP receives a Probe Request from a station with a CCC value equal to N−2, where N is an integer number representing the CCC value associated with a current Configuration Information Set (i.e., the Configuration Information Set stored in record of current Configuration Information Set 705). The AP may examine the simplified record of past Configuration Information Set for CCC value N−2 (shown as row 714) and the simplified record of past Configuration Information Set for CCC value N−1 (shown as row 716) to determine the changed IEs. The AP may send the IE IDs and the current IE contents corresponding to the changed IEs to the station in a simplified Probe Response.

According to an example embodiment, stations may update their record of stored Configuration Information Set of an AP when they receive a beacon frame with a CCC IE from the AP. According to an example embodiment, for a station that has sent a Probe Request with a CCC value that triggers the AP to send a simplified Probe Response (since the station knows the context of the simplified Probe Response), the station can determine (or reconstruct) the contents of the complete set of the IEs in the Configuration Information Set for the AP, using the contents of the simplified Probe Response and its own record of stored Configuration Information Set. If it is assumed that the CCC value transmitted in the simplified Probe Response is always the one associated with the current configuration of the AP, the station may update its record of stored Configuration Information Set for the AP. However, for a station that receives a simplified Probe Response that is in response to a Probe Request that it did not transmit, the station may not be able to determine if the simplified Probe Response is a regular Probe Response or a simplified Probe Response. Therefore, the station may store an incomplete or non-up-to-date record of the Configuration Information Set for the AP.

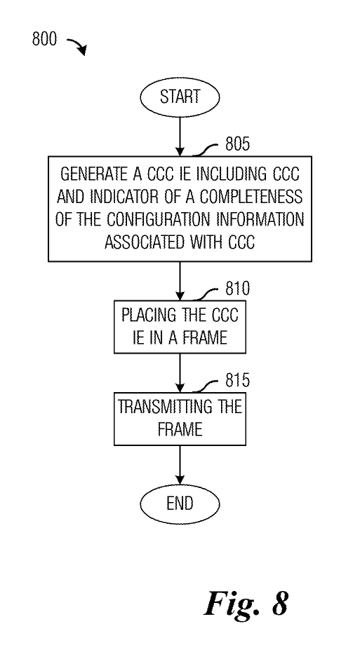

FIG. 8 illustrates a flow diagram of example operations 800 occurring in a transmitting device as the transmitting device transmits frame comprising a CCC IE. Operations 800 may be indicative of operations occurring in a transmitting device, such as an AP as it transmits a (normal or simplified) Probe Response or a beacon, or a station as it transmits a Probe Request.

Operations 800 may begin with the transmitting device generating a CCC IE (block 805). The CCC IE may be included in a transmission made by the transmitting device, such as in a (normal or simplified) Probe Response, a beacon, a Probe Request, and the like. According to an example embodiment, the CCC IE may include a CCC value and an indicator of the completeness of the configuration information that is explicitly included in the same frame and is associated with the CCC value in the CCC IE. Since a Probe Request doesn't provide the configuration information, for a simple and common design of the format of the CCC IE, this indicator may be present in the CCC IE that is carried in a Probe Request, just as the way it is in a beacon or Probe Response, but the indicator has no particular meaning to a receiving device. In a more general case, the transmitting device may generate a CI IE to be transmitted in a packet or a frame. The CI IE may include a CI and an indicator of the completeness of the configuration information that is explicitly included in the same frame and is associated with the CI in the CI IE.

As an illustrative example, if the indicator is set to a first value, the full set of IEs in the Configuration Information Set may be explicitly included in the same frame, in addition to the CCC IE, while if the indicator is set to a second value, the IE identifiers and IE contents of only the IEs from the full set of IEs in the Configuration Information Set that have changed may be explicitly included in the same frame, in addition to the CCC IE. Similarly, if the indicator is set to a first value, the full set of IEs in the Configuration Information Set may be explicitly included in the same frame, in addition to the CI IE, while if the indicator is set to a second value, the IE identifiers and IE contents of only the IEs from the full set of IEs in the Configuration Information Set that have changed may be explicitly included in the same frame, in addition to the CI IE.

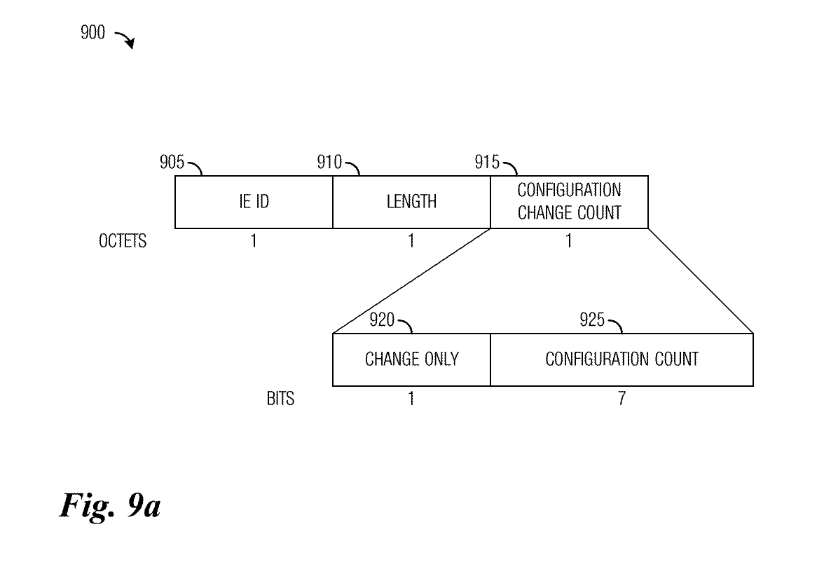

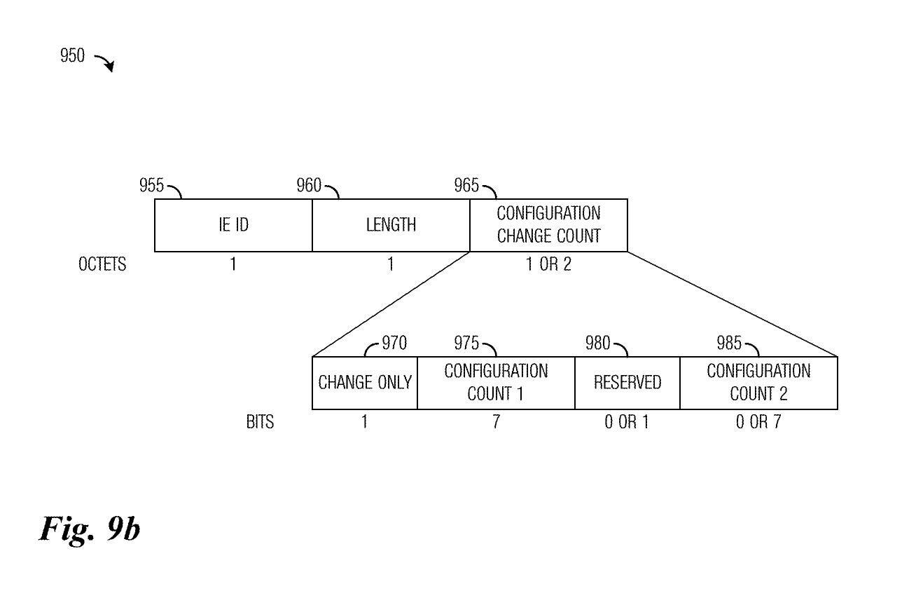

FIG. 9a illustrates a portion of a first example CCC IE 900. CCC IE 900 may be utilized in an IEEE 802.11ai compliant communications system. CCC IE 900 includes an IE identifier (IE ID) field 905 that identifies the IE as a CCC IE and a length field 910 that identifies the length of the CCC IE. CCC IE 900 also includes a CCC field 915. As shown in FIG. 9a, CCC field 915 may be 8 bits in length with a 1-bit indicator 920 and a 7-bit configuration count field 925. Indicator 920 may indicate the completeness of the configuration information that may be explicitly included in the same frame and is associated with the CCC value in configuration count field 925. As an illustrative example, indicator 920 may be a change only indicator and when indicator 920 is set to 1, the configuration information explicitly provided in the frame and associated with the CCC value in configuration count field 925 includes changed IEs, i.e., the configuration information explicitly provided in the frame comprises simplified information. For example, a reduced (or partial) set of the IEs among the Configuration Information Set may be considered as simplified information. When indicator 920 is set to 0, the configuration information explicitly provided in the frame comprises complete information. For example, a full set of the IEs among the Configuration Information Set may be considered as complete information. If the CCC IE is transmitted in a Probe Request, the transmitting device may set indicator 920 to 0 in all situations and this “0” indicator has no particular meaning to a receiving device. If the CCC IE is transmitted in a beacon, or regular and/or simplified Probe Response, the transmitting device may indicate its current CCC value in configuration count field 925 independent of beacon, or regular and/or simplified Probe Response.

When the transmitting device is an AP, the AP may broadcast simplified Probe Responses, which allows a station that sent the Probe Request with the CCC IE triggering the simplified Probe Response to update its record of stored information regarding the AP. Furthermore, a station that receives the simplified Probe Response but did not send the Probe Request that triggered the simplified Probe Response may update its record of stored Configuration Information Set regarding the AP if its stored Configuration Information Set regarding the AP corresponds to a CCC value that is one less than the CCC value in the configuration count field 925 in the received simplified Probe Response. Such a configuration may prevent stations from erroneously updating their respective record of stored information.

FIG. 9b illustrates a portion of a second example CCC IE 950. CCC IE 950 includes an IE ID field 955 that identifies the IE as a CCC IE and a length field 960 that identifies the length of the CCC IE. CCC IE 950 also includes a CCC field 965. CCC field 965 may be a variable length field. As shown in FIG. 9b, CCC field 965 may be 8 bits or 16 bits in length with a 1-bit indicator 970 and a 7-bit first configuration count field 975. Indicator 970 may indicate the completeness of the configuration information that may be explicitly included in the same frame and is associated with the CCC value in first configuration count field 975. As an illustrative example, indicator 970 may be a change only indicator and when indicator 970 is set to 1, the configuration information that is explicitly provided and associated with the CCC value in first configuration count field 975 includes changed IEs, i.e., the configuration information explicitly provided comprises a reduced set of or simplified information. When indicator 970 is set to 0, the configuration information comprises a full set of or complete information.

Furthermore, if indicator 970 is set to 1 (i.e. the exemplary value corresponding to the positive indication of “change only”), first configuration count field 975 may indicate a current CCC value and a second configuration count field 985 may be present and may indicate a past CCC value, from which point the changed IEs, as explicitly provided in the simplified Probe Response, started to accumulate, until the point of the current CCC value as indicated in first configuration count field 975. It is noted that if indicator 970 is set to 0 (i.e., the exemplary value corresponding to the negative indication of “change only”), second configuration count field 985 may not be present. A 1-bit reserved field 980 may be present if second configuration count field 985 is present, to keep the total length as one octet. If present, reserved field 980 may be unused or used for other purposes. As an illustrative example, if the current CCC value is N (an integer number) that accumulates changes referenced to CCC value N−3, then first configuration count field 975 may contain the value N and second configuration count field 985 may contain the value N−3.

The use of CCC IE 950 may allow a station to update its record of stored Configuration Information Set regarding the AP, if the station receives the simplified Probe Response from the AP but it did not send the Probe Request that triggered the simplified Probe Response and it stores a record of the AP's Configuration Information Set with a CCC value that is equal to or newer than the past CCC value in second configuration count field 985 in the received simplified Probe Response. Furthermore, the transmitting device, e.g., the AP, may transmit a single simplified Probe Response in response to multiple Probe Requests from multiple stations, which may have stored and indicated different CCC values.

It is noted that CCC IEs 900 and 950 may be specific to an IEEE 802.11ai compliant communications system. However, a more general CI IE similar to CCC IEs 900 and 950 may be utilized in other communications systems, such as other IEEE 802.11 compliant communications systems, as well as communications systems that support configuration information sets to help simplify device discovery and/or attaching.

Referring back to FIG. 8, the transmitting device may place the CCC IE in a frame, such as a beacon, a regular Probe Response, a simplified Probe Response, a Probe Request, and the like (block 810). The transmitting device may transmit the frame (block 815). The transmitting device may broadcast or unicast the frame according to the type of the transmission, e.g., simplified Probe Response, regular Probe Response, beacon, Probe Request, and the like, as well as the configuration of the CCC IE.

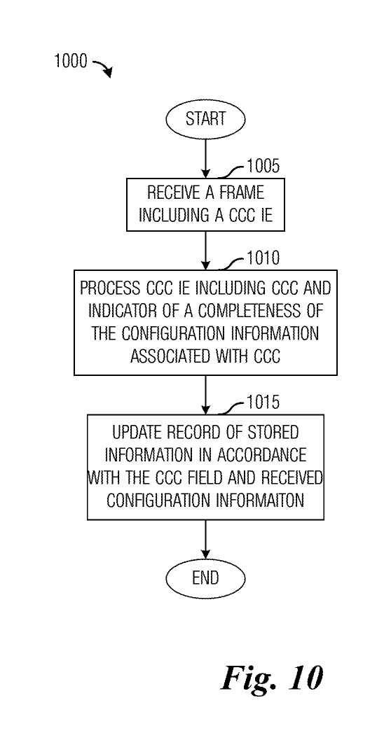

FIG. 10 illustrates a flow diagram of example operations 1000 occurring in a receiving station as the receiving station receives a frame comprising a CCC IE. Operations 1000 may be indicative of operations occurring in a receiving device, such as a station as it receives a beacon or a Probe Response.

Operations 1000 may begin with the receiving device receiving a frame, such as a beacon, a regular Probe Response, a simplified Probe Response, and the like (block 1005). The frame may include a CCC IE. According to an example embodiment, the CCC IE may include a CCC value and an indicator of the completeness of the configuration information that may be explicitly included in the same frame and is associated with the CCC value in the CCC IE. In a more general case, the receiving device may receive a CI IE in a packet or a frame. The CI IE may include a CI and an indicator of the completeness of the configuration information that may be explicitly included in the same frame and is associated with the CI in the CI IE. The receiving device may process the CCC IE and configuration information, if any, contained in the same frame (block 1010). The receiving device may update a record of stored Configuration Information Set regarding an AP corresponding to a CCC value in the CCC IE in accordance with the CCC IE (block 1015) and configuration information that is explicitly included in the same frame. If receiving device is a station and if the indicator in the CCC IE indicates that the configuration information included is regular configuration information, the receiving device may update the record of stored information regarding the AP without issue. If receiving device is a station and if the indicator in the CCC IE indicates that the configuration information included is simplified configuration information, the receiving device may update the record of stored information regarding the AP depending on the configuration of the CCC IE and whether or not the receiving device triggered a Probe Response including the CCC IE. A detailed discussion of the updating of the record of stored information regarding the AP is provided below.

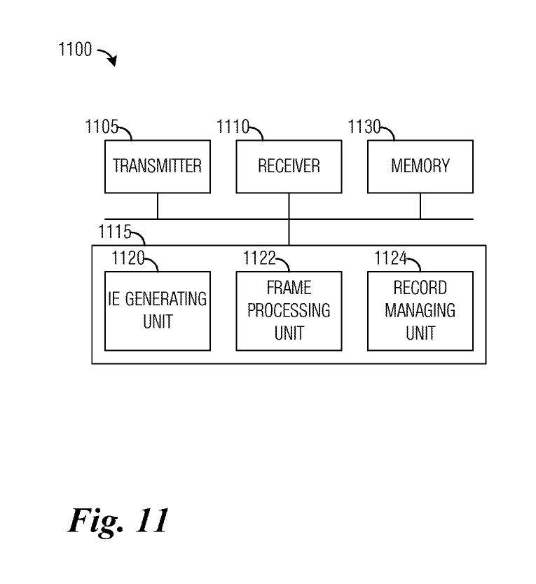

FIG. 11 illustrates an example communications device 1100. Communications device 1100 may be an implementation of a transmitting device, such as an AP, a station, and the like. Communications device 1100 may be used to implement various ones of the embodiments discussed herein. As shown in FIG. 11, a transmitter 1105 is configured to transmit regular Probe Responses, simplified Probe Responses, Probe Requests, beacons, and the like. Communications device 1100 also includes a receiver 1110 that is configured to receive regular Probe Responses, simplified Probe Responses, Probe Requests, beacons, and the like.

An IE generating unit 1120 is configured to generate a CCC IE in accordance with a record of current Configuration Information Set and a completeness of configuration information explicitly included in the frame, as comparing to the full Configuration Information Set, if communication device 1100 is an AP, or in accordance with records of stored information regarding the target AP if communications device 1100 is a non-AP station. A frame processing unit 1122 is configured to generate a frame, such as a regular Probe Responses, simplified Probe Responses, Probe Requests, beacons, and the like, containing a CCC IE generated by IE generating unit 1120. Frame processing unit 1122 is configured to process a received frame, such as a regular Probe Responses, simplified Probe Responses, Probe Requests, beacons, and the like, containing a CCC IE. A record managing unit 1124 is configured to maintain a record, such as a record of current Configuration Information Set, a simplified record of past Configuration Information Sets, a record of stored information, and the like. A memory 1130 is configured to store a record of current Configuration Information Set, a simplified record of past Configuration Information Sets, a record of stored information, CCC IEs, regular Probe Responses, simplified Probe Responses, Probe Requests, beacons, and the like.

The elements of communications device 1100 may be implemented as specific hardware logic blocks. In an alternative, the elements of communications device 1100 may be implemented as software executing in a processor, controller, application specific integrated circuit, or so on. In yet another alternative, the elements of communications device 1100 may be implemented as a combination of software and/or hardware.

As an example, receiver 1110 and transmitter 1105 may be implemented as a specific hardware block, while IE generating unit 1120, frame processing unit 1122, and record managing unit 1124 may be software modules executing in a microprocessor (such as processor 1115) or a custom circuit or a custom compiled logic array of a field programmable logic array. IE generating unit 1120, frame processing unit 1122, and record managing unit 1124 may be modules stored in memory 1130.

Although the present disclosure and its advantages have been described in detail, it should be understood that various changes, substitutions and alterations can be made herein without departing from the spirit and scope of the disclosure as defined by the appended claims.

What is claimed is:

1. A method for operating a transmitting device, the method comprising:
generating, by the transmitting device, a configuration index (CI) information element (IE), the CI IE including a CI value and an indicator of a completeness of a configuration information included with the CI IE, wherein the completeness of the configuration information included with the CI IE is one of complete information and simplified information;
placing, by the transmitting device, the CI IE in a frame; and
transmitting, by the transmitting device, the frame.

2. The method of claim 1, further comprising placing the configuration information included with the CI IE in the frame.

3. The method of claim 1, wherein the indicator comprises a 1-bit value.

4. The method of claim 3, wherein the indicator being equal to 1 indicates that the completeness of the configuration information included with the CI IE is simplified information.

5. The method of claim 1, wherein the frame comprises one of a Generic Advertisement Service Request frame and a Generic Advertisement Service Response frame.

6. The method of claim 1, wherein the frame comprises one of a beacon, a simplified Probe Response, a regular Probe Response, and a Probe Request.

7. A method for operating a transmitting device in an IEEE 802.11ai compliant communications system, the method comprising:
generating, by the transmitting device, a configuration change count (CCC) information element (IE), the CCC IE including a CCC value and an indicator of a completeness of a configuration information included with the CCC IE, wherein the completeness of the configuration information included with the CCC IE is one of a full set of a Configuration Information Set and a reduced set of the Configuration Information Set;
placing, by the transmitting device, the CCC IE in a frame; and
transmitting, by the transmitting device, the frame.

8. The method of claim 7, further comprising placing the configuration information included with the CCC IE in the frame.

9. The method of claim 7, wherein the frame comprises one of a beacon, a simplified Probe Response, a regular Probe Response, and a Probe Request.

10. The method of claim 7, wherein the indicator comprises a 1-bit value.

11. The method of claim 10, wherein the indicator being equal to 1 indicates that the completeness of the configuration information is a reduced set of the Configuration Information Set.

12. The method of claim 7, wherein the reduced set of the Configuration Information Set comprises first IE identifiers and first IE values of a subset of first IEs associated with the CCC value that has changed relative to second IEs associated with a past CCC value.

13. The method of claim 7, wherein the full set of the Configuration Information Set comprises all first IEs associated with the CCC value.

14. The method of claim 7, wherein the transmitting device comprises an access point, and wherein the frame comprises one of a beacon, a simplified Probe Response, and a regular Probe Response.

15. The method of claim 7, wherein the transmitting device comprises a station, and wherein the frame comprises a Probe Request.

16. A transmitting device comprising:
a processor configured to generate a configuration index (CI) information element (IE), the CI IE including a CI value and an indicator of a completeness of a configuration information included with the CI IE, wherein the completeness of the configuration information included with the CI IE is one of complete information and simplified information, and to place the CI IE in a frame; and
a transmitter operatively coupled to the processor, the transmitter configured to transmit the frame.

17. The transmitting device of claim 16, wherein the processor is configured to place the configuration information included with the CI IE in the frame.

18. The transmitting device of claim 16, wherein the indicator comprises a 1-bit value.

19. The transmitting device of claim 18, wherein the indicator being equal to 1 indicates that the completeness of the configuration information included with the CI IE is simplified information.

20. The transmitting device of claim 16, wherein the frame comprises one of a Generic Advertisement Service Request frame and a Generic Advertisement Service Response frame.

21. The transmitting device of claim 16, wherein the frame comprises one of a beacon, a simplified Probe Response, a regular Probe Response, and a Probe Request.

22. An IEEE 802.11ai compliant transmitting device comprising:
a processor configured to generate a configuration change count (CCC) information element (IE), the CCC IE including a CCC value and an indicator of a completeness of a configuration information included with the CCC IE, wherein the completeness of the configuration information included with the CCC IE is one of a full set of a Configuration Information Set and a reduced set of the Configuration Information Set, and to place the CCC IE in a frame; and
a transmitter operatively coupled to the processor, the transmitter configured to transmit the frame.

23. The IEEE 802.11ai compliant transmitting device of claim 22, wherein the processor is configured to place the configuration information included with the CCC IE in the frame.

24. The IEEE 802.11ai compliant transmitting device of claim 22, wherein the frame comprises one of a beacon, a simplified Probe Response, a regular Probe Response, and a Probe Request.

25. The IEEE 802.11ai compliant transmitting device of claim 22, wherein the indicator comprises a 1-bit value.

26. The IEEE 802.11ai compliant transmitting device of claim 25, wherein the indicator being equal to 1 indicates that the completeness of the configuration information that is to be explicitly included is a reduced set of the Configuration Information Set.

27. The IEEE 802.11ai compliant transmitting device of claim 22, wherein the reduced set of the Configuration Information Set comprises first IE identifiers and first IE values of a subset of first IEs associated with the CCC value that has changed relative to second IEs associated with a past CCC value.

28. The IEEE 802.11ai compliant transmitting device of claim 22, wherein the full set of the Configuration Information Set comprises all first IEs associated with the CCC value.

29. The IEEE 802.11ai compliant transmitting device of claim 22, wherein the transmitting device comprises an access point, and wherein the frame comprises one of a beacon, a simplified Probe Response, and a regular Probe Response.

30. The IEEE 802.11ai compliant transmitting device of claim 22, wherein the transmitting device comprises a station, and wherein the frame comprises a Probe Request.
